(19) United States
(12) Patent Application Publication
(10) Pub. No.: US 2013/0307680 A1
(43) Pub. Date: Nov. 21, 2013

(54) Intrusion Alarm System with Self-testing Function

(71) Applicant: Shaochang Deng, Guangdong (CN)

(72) Inventor: Shaochang Deng, Guangdong (CN)

(21) Appl. No.: 13/876,178

(22) PCT Filed: Nov. 7, 2011
(86) PCT No.: PCT/CN11/81876

§ 371 Date: Mar. 27, 2013

(30) Foreign Application Priority Data
Dec. 28, 2010 (CN) 201010607332.8

(51) Int. Cl. G08B 29/12

(52) U.S. Cl. CPC G08B 29/12
USPC 340/514

(57) ABSTRACT

An intrusion alarm system with a self-testing function contains a controller, at least two intrusion detectors, a timer and an indicator. At least one of the intrusion detectors is installed at an entry/exit way while the remaining intrusion detectors are installed at other locations. The intrusion detectors send a trigger signal to the controller when triggered. Upon receiving a trigger signal from an intrusion detector installed at an entry/exit way, the controller starts the timer, and upon receiving a trigger signal from an intrusion detector installed at another location, the controller stops the timer. When the timer stops, the controller indicates by means of the indicator information from any intrusion detector installed at another location that has not received a trigger signal. Without imposing any additional burden on users, the alarm system guarantees that all detectors contained in said system remain in a valid state.

### FIELD OF THE INVENTION

The present invention relates to an anti-theft alarm system.

### BACKGROUND OF THE INVENTION

A conventional anti-theft alarm system contains an intrusion detector (called detector hereafter) fixed on a front end thereof. The detector operates effectively by using the following two methods: A). An output of the detector and a signal transmission between the detector and the controller are detected, so if some problems of the output of the detector and the signal transmission between the detector and the controller happen, the anti-theft alarm system operates, but its detecting function decreases. For example, a detecting range of microwave detectors diminishes after a long period of using time. B). The anti-theft alarm system has to be checked manually and regularly. For example, the user has to check the anti-theft alarm system regularly, including a walk check, i.e., the examiner walks around a detecting area of the detector so as to confirm whether the detector can operate, wherein a checking period is one year. However, such a regular check does not work and one year of checking time is too long.

In addition, if the anti-theft alarm system has a failed operation because of environment change. For instance, if a passive infrared detector is fixed at a lower temperature, its detecting range is in compliance with design requirement. While the temperature increases, the detecting range decreases, the detector accordingly cannot detect an intruder.

The present invention has arisen to mitigate and/or obviate the afore-described disadvantages.

### SUMMARY OF THE INVENTION

The primary object of the present invention is to provide an intrusion alarm system with a self-testing function which is capable of overcoming the shortcomings of the anti-theft alarm system.

Another object of the present invention is to provide an intrusion alarm system with a self-testing function which has low production cost and operates conveniently and effectively.

To obtain the above objective, an intrusion alarm system with a self-testing function provided by the present invention contains: a controller, at least two intrusion detectors, a timer and an indicator.

At least one of the intrusion detectors is installed at an entry/exit way while the remaining intrusion detectors are installed at other locations; the intrusion detectors send a trigger signal to the controller when triggered, upon receiving a trigger signal from an intrusion detector installed at an entry/exit way, the controller starts the timer, and upon receiving a trigger signal from an intrusion detector installed at another location, the controller stops the timer, when the timer stops, the controller indicates by means of the indicator information from any intrusion detector installed at another location that has not received a trigger signal; without imposing any additional burden on users, the alarm system guarantees that all detectors contained in said system remain in a valid state.

Preferably, after the controller is indicated by the indicator to know the intrusion detector which does not receive a trigger signal and is installed at other location, the other intrusion detectors, which do not send the trigger signal, release an indication.

Preferably, the at least one of the intrusion detectors is a magnetic-switch intrusion detector or a movable intrusion detector.

Preferably, the indicator is a visible indicator.

Preferably, the indicator is a LCD monitor, a digital tube or a LED light.

Preferably, the indicator is an audible indicator.

Preferably, the indicator is a speech synthesizer.

Preferably, the controller is a microprocessor.

Preferably, the controller connects with the at least two intrusion detectors in a wired manner or a wireless manner, and the trigger signal is switch information or digital encoding information.

### BRIEF DESCRIPTION OF THE DRAWINGS

FIG. 1 is a diagram of an intrusion alarm system with a self-testing function according to the present invention.

### DETAILED DESCRIPTION OF THE PREFERRED EMBODIMENTS

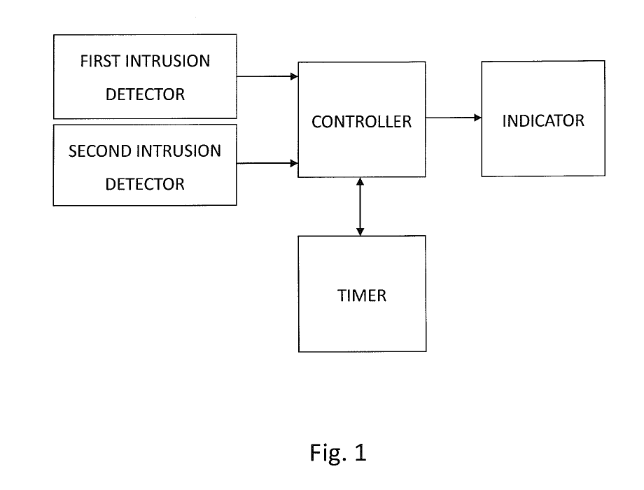

FIG. 1 is a diagram of an intrusion alarm system with a self-testing function according to the present invention. Referring to FIG. 1, a first intrusion detector 1 is a magnetic-switch intrusion detector installed at a location of an entry/exit way, such as a gateway, or the first intrusion detector 1 is a movable intrusion detector installed at an aisle of the gateway or a hall. A second intrusion detector 2 is an intrusion detector installed at other location of a building. These intrusion detectors are used to be triggered by user within a certain time, for example, a magnetic-switch intrusion detector installed on a window or a movable intrusion detector installed in a room.

A controller 3 is a microprocessor.

An indicator 4 is a visible indicator, such as a LCD monitor, a digital tube or a LED light. Also, the indicator 4 is an audible indicator, such as a speech synthesizer. Thereby, the indicator 4 is provided to indicate which intrusion detector does not send a trigger signal within a set time, such that the user knows which intrusion detector fails to operate.

When the user knows the intrusion detector fails to operate, he/she triggers the intrusion detector, and then if the intrusion detector sends a trigger signal, it means the intrusion detector operates normally so the controller cancels a warming automatically. If the intrusion detector does not send a trigger signal, it means the intrusion detector operates abnormally and is broken.

A timer 5 is started and is set a time so that when the first intrusion detector 1 sends another trigger signal, a set time set by the timer 5 is not be prolonged. The timer 5 is stopped after the set time or is stopped by the controller. In addition, the shorter set time the controller stops, the sooner a failed operation of the intrusion detector is found, but the greater chance of an error indication occurs, and vice versa. A determination to an appropriate set time of the timer is estimated after the user enters the building under a normal condition, so the longest time, when all intrusion detectors are triggered, is prolonged.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. An intrusion alarm system with a self-testing function comprising:
a controller, at least two intrusion detectors, a timer and an indicator, characterized in that:
at least one of the intrusion detectors is installed at an entry/exit way while the remaining intrusion detectors are installed at other locations;
the intrusion detectors send a trigger signal to the controller when triggered, upon receiving a trigger signal from an intrusion detector installed at an entry/exit way, the controller starts the timer, and upon receiving a trigger signal from an intrusion detector installed at another location, the controller stops the timer, when the timer stops, the controller indicates by means of the indicator information from any intrusion detector installed at another location that has not received a trigger signal;
without imposing any additional burden on users, the alarm system guarantees that all detectors contained in said system remain in a valid state.

2. The intrusion alarm system with the self-testing function as claimed in claim 1, characterized in that after the controller is indicated by the indicator to know the intrusion detector which does not receive a trigger signal and is installed at other location, the other intrusion detectors, which do not send the trigger signal, release an indication.

3. The intrusion alarm system with the self-testing function as claimed in claim 1, characterized in that the at least one of the intrusion detectors is a magnetic-switch intrusion detector or a movable intrusion detector.

4. The intrusion alarm system with the self-testing function as claimed in claim 1, characterized in that the indicator is a visible indicator.

5. The intrusion alarm system with the self-testing function as claimed in claim 4, characterized in that the indicator is a LCD monitor, a digital tube or a LED light.

6. The intrusion alarm system with the self-testing function as claimed in claim 1, characterized in that the indicator is an audible indicator.

7. The intrusion alarm system with the self-testing function as claimed in claim 6, characterized in that the indicator is a speech synthesizer.

8. The intrusion alarm system with the self-testing function as claimed in claim 1, characterized in that the controller is a microprocessor.

9. The intrusion alarm system with the self-testing function as claimed in claim 1, characterized in that the controller connects with the at least two intrusion detectors in a wired manner or a wireless manner, and the trigger signal is switch information or digital encoding information.

10. The intrusion alarm system with the self-testing function as claimed in claim 2, characterized in that the at least one of the intrusion detectors is a magnetic-switch intrusion detector or a movable intrusion detector.

11. The intrusion alarm system with the self-testing function as claimed in claim 2, characterized in that the indicator is a visible indicator.

12. The intrusion alarm system with the self-testing function as claimed in claim 11, characterized in that the indicator is a LCD monitor, a digital tube or a LED light.

13. The intrusion alarm system with the self-testing function as claimed in claim 2, characterized in that the indicator is an audible indicator.

14. The intrusion alarm system with the self-testing function as claimed in claim 13, characterized in that the indicator is a speech synthesizer.

15. The intrusion alarm system with the self-testing function as claimed in claim 2, characterized in that the controller is a microprocessor.

16. The intrusion alarm system with the self-testing function as claimed in claim 2, characterized in that the controller connects with the at least two intrusion detectors in a wired manner or a wireless manner, and the trigger signal is switch information or digital encoding information.
